(19) United States
(12) Patent Application Publication
(10) Pub. No.: US 2026/0241698 A1
(43) Pub. Date: Aug. 20, 2026

(54) LIQUID EJECTION APPARATUS, LIQUID AMOUNT DETECTION METHOD, AND STORAGE MEDIUM

(71) Applicant: Konica Minolta, Inc., Tokyo (JP)

(72) Inventor: Hiroshi SHIBATA, Tokyo (JP)

(21) Appl. No.: 19/535,389

(22) Filed: Feb. 10, 2026

(30) Foreign Application Priority Data
Feb. 20, 2025 (JP) 2025-025811

(51) Int. Cl. B41J 2/175; B41J 2/19; B41J 2/195; B41J 29/377

(52) U.S. Cl. CPC B41J 2/17566; B41J 2/19; B41J 2/195; B41J 29/377

(57) ABSTRACT

A liquid ejection apparatus includes: a liquid reservoir that stores liquid; a path that communicates with the liquid reservoir; a pump that sucks air from the liquid reservoir via the path; a pressure gauge that measures a pressure in the path; and a hardware processor that detects a liquid amount in the liquid reservoir based on a detection result of the pressure gauge.

### CROSS-REFERENCE TO RELATED APPLICATION

The entire disclosure of Japanese Patent Application No. 2025-025811 filed on Feb. 20, 2025, is incorporated herein by reference in its entirety.

### BACKGROUND OF THE INVENTION

### Technical Field

The present disclosure relates to a liquid ejection apparatus, a liquid amount detection method, and a storage medium.

### Description of Related Art

Conventionally, a liquid ejection apparatus that ejects liquid is known. In the liquid ejection apparatus, when the liquid is stored in an amount equal to or larger than the capacity of a liquid reservoir in which the liquid to be ejected is stored, the liquid may overflow, and the liquid ejection apparatus may malfunction. Therefore, it is necessary to control the liquid amount in the liquid reservoir so that the liquid amount does not exceed a predetermined value.

Therefore, for example, Japanese Unexamined Patent Application Publication No. 2008-238127 describes a configuration in which a liquid level sensor is provided in a liquid reservoir to enable detection of the liquid level height of the liquid reservoir and control the liquid amount.

### SUMMARY OF THE INVENTION

However, when the amount of the liquid stored in the liquid reservoir is detected by the liquid level sensor, it is necessary to secure a physical space in which the liquid level sensor is installed in the liquid reservoir, and there is a restriction on the layout. Furthermore, providing the liquid level sensor increases the cost of the liquid ejection apparatus. In addition, there is a concern that the liquid level sensor may perform erroneous detection due to vapor of the liquid accumulated in the liquid reservoir.

As described above, attempting to detect the amount of liquid stored in the liquid reservoir by the liquid level sensor raises another problem aside from malfunction of the liquid ejection apparatus. Therefore, it is required to detect the liquid amount in the liquid reservoir without using a liquid level sensor.

The present disclosure has been made in view of such circumstances. It is an object of the present invention to provide a liquid ejection apparatus, a liquid amount detection method, and a storage medium that can detect a liquid amount in a liquid reservoir without using a liquid level sensor.

To achieve at least one of the abovementioned objects, a liquid ejection apparatus reflecting one aspect of the present invention comprises: a liquid reservoir that stores liquid; a path that communicates with the liquid reservoir; a pump that sucks air from the liquid reservoir via the path; a pressure gauge that measures a pressure in the path; and a hardware processor that detects a liquid amount in the liquid reservoir based on a detection result of the pressure gauge.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a side cross-sectional view of an inkjet recording apparatus according to a first embodiment;

FIG. 2 is a schematic configuration diagram of a liquid feed section in the inkjet recording apparatus according to the first embodiment;

FIG. 3 is a cross-sectional side view of a deaeration module;

FIG. 4 is an internal view of a first trap in which a fitting is attached to a discharge port;

FIG. 5 is a block diagram of the inkjet recording apparatus;

FIG. 6 is a flowchart of liquid amount detection processing;

FIG. 7 is a graph illustrating a change in a pressure value from the start of depressurization according to a liquid amount in a liquid reservoir in the liquid amount detection processing;

FIG. 8 is a graph illustrating a change in the pressure value from the start of air blowing according to the liquid amount in the liquid reservoir in the liquid amount detection processing;

FIG. 9 is a graph illustrating a change in the pressure value from the start of suction inside a gas permeable membrane according to the liquid amount in the liquid reservoir in the liquid amount detection processing;

FIG. 10 is a schematic configuration diagram of a liquid feed section in an inkjet recording apparatus according to a second embodiment; and

FIG. 11 is a schematic configuration diagram of a modification example of the liquid feed section in the inkjet recording apparatus according to the second embodiment.

### DETAILED DESCRIPTION

Hereinafter, one or more embodiments of a liquid ejection apparatus according to the present invention will be described with reference to the drawings. However, the scope of the present invention is not limited to the disclosed embodiments.

In the following description, components having the same functions and configurations are denoted by the same reference numerals, and the description thereof will be omitted.

### Overall Configuration of Liquid Ejection Apparatus

### First Embodiment

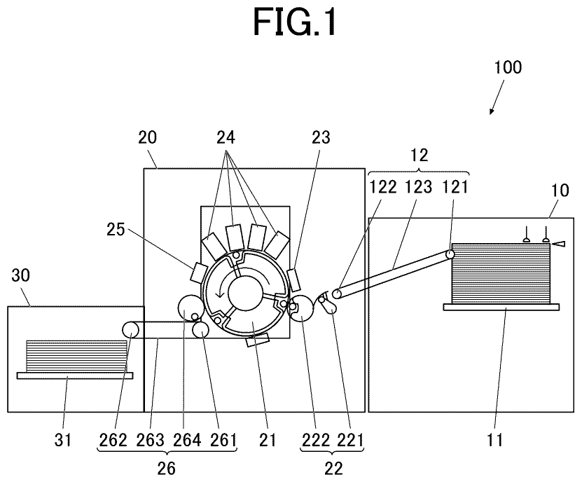

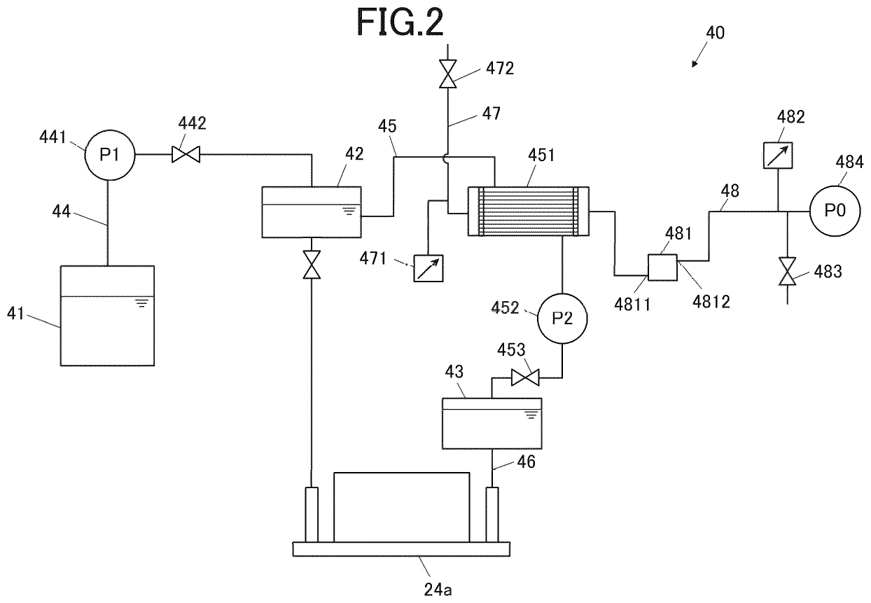

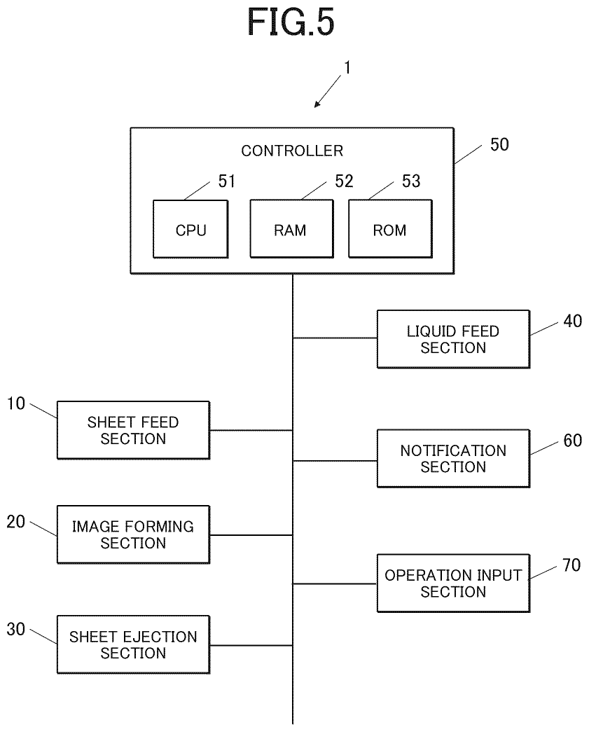

FIG. 1 is a side cross-sectional view of a main configuration of an inkjet recording apparatus 100 according to a first embodiment that ejects ink, which is one form of a liquid ejection apparatus. The inkjet recording apparatus 100 includes, for example, a sheet feed section 10, an image forming section 20, a sheet ejection section 30, a liquid feed section 40 (see FIG. 2), a controller (hardware processor) 50, a notification section 60, and an operation input section 70 (see FIG. 5 for all of these components).

The inkjet recording apparatus 100 conveys a recording medium from the sheet feed section 10 to the image forming section 20 under the control of the controller 50. Then, the controller 50 causes the image forming section 20 to form an image on the recording medium with ink supplied from the liquid feed section 40. After the image formation, the controller 50 ejects the recording medium to the sheet ejection section 30.

### Sheet Feed Section

The sheet feed section 10 stores a recording medium before image formation. The sheet feed section 10 conveys a recording medium to the image forming section 20 under the control of the controller 50. The sheet feed section 10 includes a sheet feed tray 11 and a conveyance section 12.

### Sheet Feed Tray

The sheet feed tray 11 is a plate member that stores the recording medium. The sheet feed tray 11 is provided so that one or more recording media can be placed thereon. The sheet feed tray 11 moves vertically up and down in accordance with the amount of the recording media placed thereon. Through this vertical movement, the sheet feed tray 11 is held at a position where the uppermost recording medium is conveyed by the conveyance section 12.

### Conveyance Section

The conveyance section 12 conveys the recording medium from the sheet feed tray 11 to the image forming section 20. The conveyance section 12 includes a conveyance mechanism. The conveyance mechanism drives a belt 123 to convey the recording medium on the belt 123. The belt 123 has a ring shape, and the inner side of the ring is supported by a plurality of rollers 121 and 122. The conveyance section 12 delivers the uppermost recording medium placed on the sheet feed tray 11 onto the belt 123 and conveys the recording medium along the belt 123.

### Image Forming Section

The image forming section 20 records an image on the recording medium in cooperation with the liquid feed section 40 under the control of the controller 50. The image forming section 20 includes an image forming drum 21, a handover unit 22, a sheet heater 23, head units 24, an irradiation section 25, and a delivery part 26.

### Image Forming Drum

The image forming drum 21 holds the recording medium along its cylindrical outer peripheral surface and conveys the recording medium with rotation. The conveyance surface of the image forming drum 21 faces the sheet heater 23, the head units 24, and the irradiation section 25, and performs image formation processing on the recording medium being conveyed.

### Handover Unit

The handover unit 22 is provided at a position between the conveyance section 12 and the image forming drum 21. The handover unit 22 includes a claw 221 and a handover drum 222.

The claw 221 is a cylindrical member that holds one end of the recording medium conveyed by the conveyance section 12. The handover drum 222 is a member that guides the recording medium held by the claw 221.

The handover unit 22 picks up the recording medium on the conveyance section 12 with the claw 221 and places the recording medium along the outer peripheral surface of the handover drum 222. The handover unit 22 hands over the recording medium to the image forming drum 21 by this operation.

### Sheet Heater

The sheet heater 23 includes, for example, a heating wire and generates heat in response to energization. The sheet heater 23 is controlled by the controller 50 to generate heat so that the recording medium passing through the vicinity of the sheet heater 23 reaches a predetermined temperature. The sheet heater 23 is disposed adjacent to the outer peripheral surface of the image forming drum 21 and upstream of the head units 24 in the conveyance direction of the recording medium.

A temperature sensor (not illustrated) is provided adjacent to the sheet heater 23. With the temperature sensor, the controller 50 performs detection of the temperature around the sheet heater 23. Based on the detected temperature, the controller 50 controls heat generation of the sheet heater 23.

### Head Units

Each of the head units 24 includes, for example, a plurality of inkjet heads 24a (refer to FIG. 2). The head units 24 form an image by ejecting ink droplets onto the recording medium from nozzles. The head units 24 corresponding to respective colors of C (cyan), M (magenta), Y (yellow), and K (black) are provided. In FIG. 1, the head units 24 corresponding to the respective colors of Y, M, C, and K are provided in this order from the upstream in the conveyance direction of the recording medium.

Here, the direction perpendicular to the conveyance direction of the recording medium in plan view is defined as the main scanning direction. A plurality of head units 24 are arranged with a length (width) covering the entire recording medium in the main scanning direction. That is, the inkjet recording apparatus 100 is a single-pass line-head type inkjet recording apparatus. Each of the head units 24 is configured by arranging a plurality of inkjet heads 24a, which are droplet ejection heads. The number of the head units 24 may be five or more or three or less. Further, a single inkjet head 24a may constitute the head unit 24.

The ink ejected from the head unit 24 is, for example, ultraviolet curable ink (UV ink). The ultraviolet curable ink contains, for example, an ultraviolet curable resin. The ultraviolet curable resin contains a monomer and a polymerization initiator. When the ink containing an ultraviolet curable resin is irradiated with ultraviolet rays, the monomer is polymerized and cured by the action of the polymerization initiator, and the ink is fixed to the recording medium.

The ink ejected from the head unit 24 may contain a gelling agent. Ink containing a gelling agent undergoes a phase change between a gel state and a liquid (sol) state depending on temperature. Ink containing a gelling agent has a phase change temperature of, for example, about 40 to 100° C., and uniformly liquefies (solizes) when heated above this phase change temperature. On the other hand, ink containing a gelling agent gels at about normal room temperature, that is, about 0 to 30° C. Therefore, the ink in the head unit 24 is heated to an appropriate temperature by an ink heater or the like (not illustrated) to be brought into the sol state. Then, after being ejected and landing on the recording medium, the ink transitions appropriately to the gel state while the recording medium is being conveyed by the image forming drum 21.

### Irradiation Section

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided adjacent to the outer peripheral surface of the image forming drum 21. In addition, the irradiation section 25 is disposed downstream of the head units 24 in the conveyance direction of the recording medium. The irradiation section 25 irradiates the recording medium on which the ink has been ejected with energy rays. In a case where the ink on the recording medium is UV ink, the ink is cured by the action of the energy rays.

The fluorescent tube that emits ultraviolet rays is not limited to the low-pressure mercury lamp. The fluorescent tube may be a mercury lamp having an operating pressure of a few hundred Pa to 1 MPa, for example. The fluorescent tube may be a light source usable as a germicidal lamp, for example, a cold-cathode tube, an ultraviolet laser light source, a metal halide lamp, a light-emitting diode, or the like. It is desirable that the fluorescent tube is a power-saving light source capable of emitting ultraviolet rays at higher illuminance. The light source may be, for example, a light-emitting diode. The energy rays are not limited to the ultraviolet rays and may be energy rays having the property of curing the ink depending on the properties of the ink. The light source is also selected according to the type of energy rays.

In the above description, the case where the head unit 24 ejects ultraviolet curable ink or ink containing a gelling agent is exemplified, but the present invention is not limited thereto. The ink ejected from the head unit 24 may be water-based ink or ink having other physical properties.

### Delivery Part

The delivery part 26 includes a conveyance mechanism. The conveyance mechanism drives a ring-shaped belt 263 whose inner side is supported by a plurality of rollers 261 and 262 to convey the recording medium. The delivery part 26 includes a cylindrical handover roller 264. The handover roller 264 hands over the recording medium from the image forming drum 21 to the conveyance mechanism. The delivery part 26 conveys the recording medium delivered onto the belt 263 by the handover roller 264 and sends the recording medium to the sheet ejection section 30.

### Sheet Ejection Section

The recording medium on which the image has been formed by the image forming section 20 is ejected to the sheet ejection section 30. The sheet ejection section 30 includes a plate-shaped sheet ejection tray 31. The recording medium sent from the image forming section 20 by the delivery part 26 is placed on the sheet ejection tray 31. The sheet ejection section 30 stores the recording medium until the user takes out the recording medium.

### Liquid Feed Section

FIG. 2 illustrates a schematic configuration diagram of the liquid feed section 40. The liquid feed section 40 includes a plurality of main tanks 41 that store the ink of the respective colors. The liquid feed section 40 supplies the ink of the respective colors in the plurality of main tanks 41 to the inkjet heads 24a of the respective head units 24. The liquid feed section 40 enables the ink of the respective colors to be ejected from the nozzles through this control.

As illustrated in FIG. 2, the liquid feed section 40 includes a main tank 41, a first sub-tank 42, and a second sub-tank 43. The liquid feed section 40 also includes a deaeration module 451 that removes gas dissolved in the ink before the ink is supplied to one of the head units 24.

### Main Tank

The main tank 41 is a tank that stores the ink to be supplied to each part of the liquid feed section 40. The main tank 41 is, for example, a rigid, sealed tank made of metal. The main tank 41 communicates with the first sub-tank 42 via a supply pipe 44.

### First Sub-Tank

The first sub-tank 42 includes one or more ink inflow chambers having a smaller volume than the main tank 41. The ink pumped out of the main tank 41 by a supply pump 441 is stored in the first sub-tank 42. By providing the first sub-tank 42, pressure fluctuation due to pulsation when the supply pump 441 supplies the ink in the main tank 41 is alleviated. The first sub-tank 42 communicates with the second sub-tank 43 via a liquid feed pipe 45.

Ink that is not ejected from the inkjet head 24a is collected into the first sub-tank 42 via a circulation channel that provides communication between an outlet of the inkjet head 24a and the first sub-tank 42. By providing such a circulation channel, it is possible to circulate the ink so as to pass through the deaeration module 451 from the first sub-tank 42 at the time of maintenance, thereby removing dissolved gas from the ink.

Note that the circulation channel is not limited to such a configuration in which the circulation channel passes through the inkjet head 24a. For example, the circulation channel may be a channel that communicates the first sub-tank 42 with a portion of the liquid feed pipe 45 that is downstream of a liquid feed pump 452 in the liquid feed direction and upstream of a liquid feed valve 453 in the liquid feed direction (both will be described later).

### Second Sub-Tank

The second sub-tank 43 includes a small tank chamber that temporarily stores ink that has been deaerated by the deaeration module 451. The capacity of the second sub-tank 43 is substantially the same as that of the first sub-tank 42, for example. The second sub-tank 43 communicates with the inlet of each of the inkjet heads 24a via a supply path 46. The ink in the second sub-tank 43 is supplied to each inkjet head 24a according to the amount of ink to be ejected from the nozzles.

Furthermore, the second sub-tank 43 is provided with a known back pressure adjustment means (not illustrated). The back pressure adjustment means suppresses ink from leaking out of the nozzles of the inkjet head 24a by applying appropriate negative pressure to the inkjet head 24a.

### Supply Pipe

The supply pipe 44 is an ink channel that allows the main tank 41 and the first sub-tank 42 to communicate with each other. The supply pipe 44 is provided with the supply pump 441 and a supply valve 442. The supply pump 441 and the supply valve 442 operate under the control of the controller 50. The ink in the main tank 41 is supplied to the first sub-tank 42 via the supply pipe 44 by driving of the supply pump 441 when the supply valve 442 is opened. The entire main tank 41 is replaceable. Further, the main tank 41 can be attached to and detached from the supply pipe 44 regardless of the driving state of the supply pump 441.

### Liquid Feed Pipe

The liquid feed pipe 45 is an ink channel that allows the first sub-tank 42 and the second sub-tank 43 to communicate with each other. The liquid feed pipe 45 is provided with the deaeration module 451, the liquid feed pump 452, the liquid feed valve 453, and the like.

### Deaeration Module

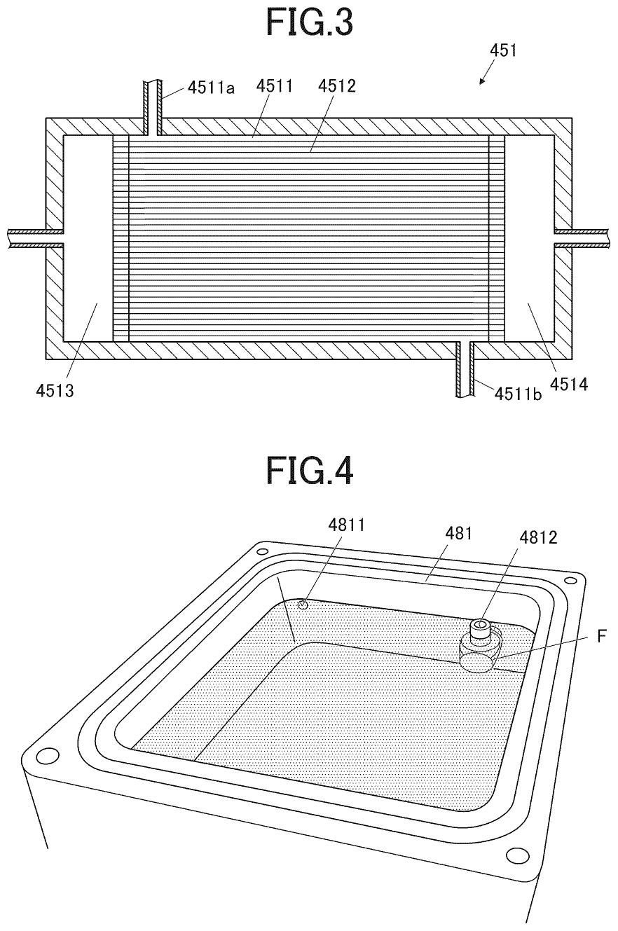

FIG. 3 shows an enlarged cross-sectional view of the deaeration module 451. The deaeration module 451 removes dissolved gas from the inflowing ink and discharges the deaerated ink. The deaeration module 451 includes an ink flow chamber 4511, a gas permeable membrane 4512, a first vacuum chamber 4513, a second vacuum chamber 4514, and the like.

### Ink Flow Chamber

The ink flow chamber 4511 is provided in a central portion of the interior of the casing forming the deaeration module 451. The ink flow chamber 4511 includes an ink inlet 4511a, receiving inflow of the ink from the first sub-tank 42 prior to deaeration. In addition, the ink flow chamber 4511 includes an ink outlet 4511b, discharging the deaerated ink to the second sub-tank 43.

Note that as illustrated in FIG. 3, the ink inlet 4511a and the ink outlet 4511b are preferably provided on a first end side and a second end side opposite to the first end side of the ink flow chamber 4511, respectively. In particular, as illustrated in FIG. 3, it is more preferable that the ink inlet 4511a and the ink outlet 4511b are provided substantially along a diagonal line of the ink flow chamber 4511. This configuration makes it easier for the ink to come in contact with the gas permeable membrane 4512, thereby increasing the deaeration efficiency of the deaeration module 451.

### Gas Permeable Membrane

The gas permeable membrane 4512 is tubular and has a membrane surface that is gas permeable. The gas permeable membrane 4512 is, for example, a hollow fiber membrane, having a number of hollow-shaped fine fiber structures, many of which are arranged in bundles extending in the axial direction of the ink flow chamber 4511.

In addition, as illustrated in FIG. 3, the gas permeable membrane 4512 is disposed so as to allow the first vacuum chamber 4513 and the second vacuum chamber 4514 to communicate with each other. Therefore, a first end of the gas permeable membrane 4512 is connected to the atmosphere via a first vacuum path 47 described later. In addition, a second end of the gas permeable membrane 4512 opposite the first end is sucked by a vacuum pump 484 via a second vacuum path 48 described later.

Note that the gas permeable membrane 4512 is preferably made of, for example, silicone. This is because silicone is highly permeable to dissolved gas in ink. This is also because silicone has high heat resistance and ink resistance.

### First Vacuum Chamber

The first vacuum chamber 4513 is provided at the first end of the deaeration module 451. The first vacuum chamber 4513 is formed by being partitioned from the ink flow chamber 4511 by a partition wall. The first vacuum chamber 4513 is connected to the atmosphere by the first vacuum path 47 on the side opposite the ink flow chamber 4511.

### Second Vacuum Chamber

The second vacuum chamber 4514 is provided at the second end of the deaeration module 451 opposite the first vacuum chamber 4513. The second vacuum chamber 4514 is formed by being partitioned from the ink flow chamber 4511 by a partition wall. The second vacuum chamber 4514 communicates with the vacuum pump 484 through the second vacuum path 48 on the side opposite the ink flow chamber 4511.

Although the form of the deaeration module 451 is not particularly limited, for example, it is preferable to use a sheet in which a plurality of gas permeable membranes 4512 are woven into a mesh shape. This is because, with the above-described configuration, the mesh openings of the gas permeable membranes 4512 become finer, making it easier for all the ink to pass through the openings of the gas permeable membranes 4512 and thereby facilitating higher deaeration efficiency. Furthermore, the above-described configuration makes it easier to obtain a certain level of strength even with a flexible gas permeable membrane 4512.

In addition, in the above description, the so-called external reflux type deaeration module 451 that deaerates ink flowing outside the gas permeable membrane 4512 is exemplified, but the present invention is not limited thereto. An internal reflux type module that deaerates ink flowing inside the gas permeable membrane 4512 may be used.

### Liquid Feed Pump, Liquid Feed Valve

Returning to FIG. 2, the liquid feed pump 452 and the liquid feed valve 453 operate under the control of the controller 50. The liquid feed pump 452 sends out, to the second sub-tank 43, the ink having flowed out from the ink outlet 4511b of the deaeration module 451 when the liquid feed valve 453 is opened. A check valve (not illustrated) is provided between the liquid feed pump 452 and the second sub-tank 43 to prevent backflow of the ink sent to the second sub-tank 43.

### First Vacuum Path

The first vacuum path 47 is an air channel that communicates with the first end of the deaeration module 451. The first vacuum path 47 is provided with a first pressure sensor 471, a hollow fiber valve 472, and the like.

### First Pressure Sensor

The first pressure sensor 471 is a known pressure gauge. The first pressure sensor 471 detects a pressure value in the first vacuum chamber 4513 and transmits the pressure value to the controller 50.

### Hollow Fiber Valve

The hollow fiber valve 472 is a solenoid valve. The hollow fiber valve 472 opens and closes in response to control signals from the controller 50, thereby venting or sealing the first vacuum path 47 to the atmosphere.

### Second Vacuum Path

The second vacuum path 48 is an air channel that communicates with the second end of the deaeration module 451. The second vacuum path 48 is provided with a first trap 481, a second pressure sensor 482, an atmospheric vent valve 483, and a vacuum pump 484.

### First Trap

The first trap 481 is provided between the deaeration module 451 and the vacuum pump 484. The first trap 481 stores therein the liquid component of the ink that has infiltrated into the gas permeable membrane 4512 and entered the second vacuum path 48. The liquid component of the ink stored in the first trap 481 is, for example, a monomer when the ink is UV ink. Providing the first trap 481 can prevent the liquid component of the ink from reaching the vacuum pump 484 and causing the vacuum pump 484 to malfunction.

Furthermore, as illustrated in FIG. 2, the first trap 481 is provided with a height difference such that an inlet port 4811 connected to the deaeration module 451 is located lower than a discharge port 4812 connected to the vacuum pump 484. This height difference may be created during the manufacturing stage of the first trap 481 by forming the multiple openings that become the inlet port 4811 and discharge port 4812 at different vertical positions. Alternatively, as illustrated in FIG. 4, this height difference may be created by attaching a known fitting F (e.g., an elbow fitting) that becomes the inlet port 4811 and/or discharge port 4812 to each of the openings that have been formed in parallel during the manufacturing stage of the first trap 481.

### Second Pressure Sensor

Returning to FIG. 2, the second pressure sensor 482 is a known pressure gauge. The second pressure sensor 482 is provided between the first trap 481 and the vacuum pump 484 in the second vacuum path 48, detects a pressure value in the second vacuum path 48, and sequentially transmits the detected pressure value to the controller 50.

### Atmospheric Vent Valve

The atmospheric vent valve 483 is a solenoid valve that can be opened and closed under the control of the controller 50. The atmospheric vent valve 483 is provided between the first trap 481 and the vacuum pump 484 and is opened when the second vacuum path 48 is made to communicate with the atmosphere.

### Vacuum Pump

The vacuum pump 484 is, for example, a diaphragm pump. Specifically, the vacuum pump 484 includes a pump chamber having an extendable diaphragm. In addition, the vacuum pump 484 includes a drive source or the like that operates the diaphragm so that the volume of the pump chamber expands and contracts. The pump chamber includes a suction port having a check valve that allows inflow of a fluid only from the outside. The pump chamber also includes a discharge port having a check valve that allows outflow of a fluid only from the inside.

Under the control of the controller 50, the vacuum pump 484 performs a suction operation when the hollow fiber valve 472 is opened, thereby sucking the inside of the gas permeable membrane 4512. By this suction operation of the vacuum pump 484, foreign matter in the gas permeable membrane 4512 is removed, and the pressure in the gas permeable membrane 4512 is reduced. Therefore, when the ink that has flowed into the ink flow chamber 4511 comes into contact with the outer membrane surface of the gas permeable membrane 4512, the dissolved gas selectively permeates the membrane surface and is removed. Then, the dissolved gas that has passed through the gas permeable membrane 4512 is discharged by the vacuum pump 484 via the second vacuum chamber 4514.

### Controller

FIG. 5 is a block diagram illustrating a configuration of the inkjet recording apparatus 100. As illustrated in FIG. 5, the controller 50 is connected to the components constituting the inkjet recording apparatus 100. The controller 50 controls the components constituting the inkjet recording apparatus 100. The controller 50 includes a central processing unit (CPU) 51, a random-access memory (RAM) 52, and a read-only memory (ROM) 53.

### CPU

The CPU 51 reads various programs and data corresponding to processing contents from a storage device of the ROM 53 or the like and executes them. In addition, the CPU 51 controls the operations of the respective components of the inkjet recording apparatus 100 according to the executed processing contents. The controller 50 functions as a sensing section that performs liquid amount detection processing, which will be described later, when the CPU 51 executes a program.

### RAM

The RAM 52 temporarily stores therein various programs and data processed by the CPU 51.

### ROM

The ROM 53 is a nonvolatile storage section such as a hard disk drive (HDD), a solid-state drive (SSD), or a flash memory. The ROM 53 stores various programs and data read by the CPU 51 or the like.

### Notification Section

The notification section 60 provides notification of various types of information under the control of the controller 50. The notification section 60 is, for example, a display part having a screen, a speaker that emits a predetermined sound, a communication section that can communicate with another device via a network, or the like.

### Operation Input Section

The operation input section 70 receives various inputs related to the operation of the inkjet recording apparatus 100 in response to user operations. The operation input section 70 includes, for example, a touch screen type input display device, up, down, left, and right movement keys for data selection, feed operation, and the like, various function keys, and the like. The operation input section 70 outputs a press signal of a key pressed by the user or an operation signal of a mouse or the like to the CPU 51 of the controller 50.

### Liquid Amount Detection Processing (First Embodiment)

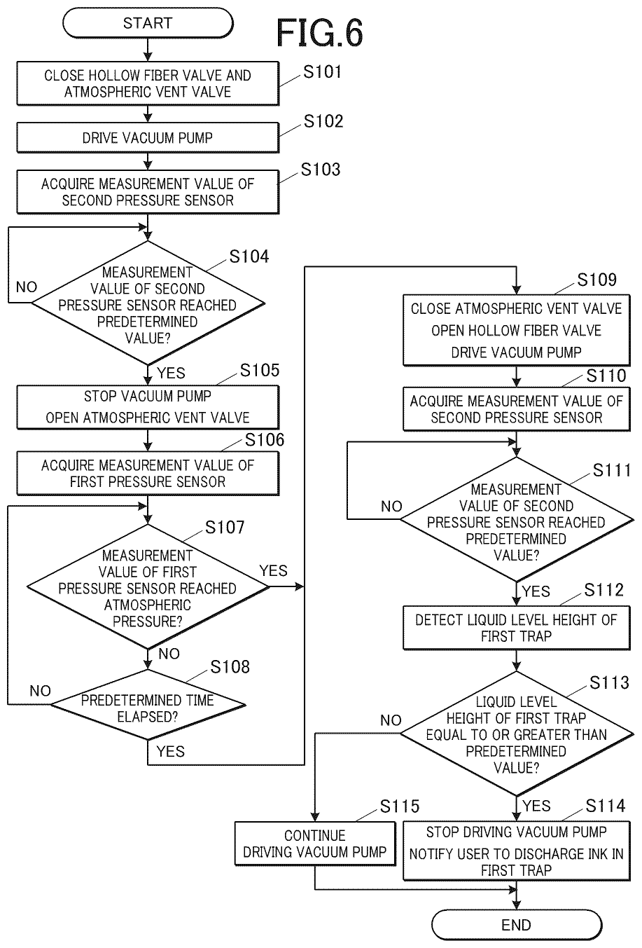

The liquid amount detection processing by the controller 50 of the inkjet recording apparatus 100 according to the first embodiment as described above will be described with reference to the flowchart of FIG. 6. In the liquid amount detection processing, the controller 50 detects the liquid amount in the first trap 481 while performing deaeration processing on the ink to be sent from the first sub-tank 42 to the second sub-tank 43.

First, the controller 50 closes the hollow fiber valve 472 and the atmospheric vent valve 483 (step S101). After closing both valves, the controller 50 drives the vacuum pump 484 (step S102). Next, the controller 50 acquires the measurement value of the second pressure sensor 482 (step S103).

The controller 50 determines whether the measurement value of the second pressure sensor 482 has reached a predetermined value (step S104). If the measurement value of the second pressure sensor 482 has reached the predetermined value (step S104; Yes), the controller 50 stops driving the vacuum pump 484 and then opens the atmospheric vent valve 483 to blow gas (air) into the second vacuum path 48 (step S105). Then, the controller 50 acquires the measurement value measured by the first pressure sensor 471 (step S106).

The controller 50 determines whether the measurement value of the first pressure sensor 471 has reached atmospheric pressure (0 kPa) (step S107). If the measurement value of the first pressure sensor 471 has reached atmospheric pressure (step S107; Yes), the controller 50 closes the atmospheric vent valve 483, opens the hollow fiber valve 472, and then drives the vacuum pump 484 again (step S109). By this control, the controller 50 discharges the liquid component of the ink in the gas permeable membrane 4512 and blows gas (air) into the first trap 481. When the atmospheric pressure is not reached (step S107; No), the controller 50 determines whether a predetermined time has elapsed (step S108). If the predetermined time has elapsed (step S108; Yes), the controller 50 performs the control of step S109 as in the case where the atmospheric pressure is reached.

The inside of the first trap 481 is depressurized by driving the vacuum pump 484 in steps S102 to S104. Here, if step S109 were performed without performing steps S105 to S108, a rapid change in pressure occurs in the first trap 481. If this happens, the liquid level in the first trap 481 may oscillate, causing the liquid component of the ink to leak out of the discharge port 4812, which may lead to malfunction of the vacuum pump 484 or other problems.

On the other hand, in the present embodiment, as described above, after the inside of the first trap 481 is set to the atmospheric pressure or a value close to the atmospheric pressure in step S107 and step S108, the hollow fiber valve 472 is opened and the vacuum pump 484 is driven in step S109. Therefore, it is possible to avoid a situation in which the liquid component of the ink in the first trap 481 leaks out of the discharge port 4812.

The controller 50 acquires the measurement value of the second pressure sensor 482 (step S110). When the measurement value of the second pressure sensor 482 has reached a predetermined value (step S111; Yes), the controller 50 detects the liquid level height of the first trap 481 based on the measurement value acquired in step S103, step S106, and step S110 (step S112; detection step).

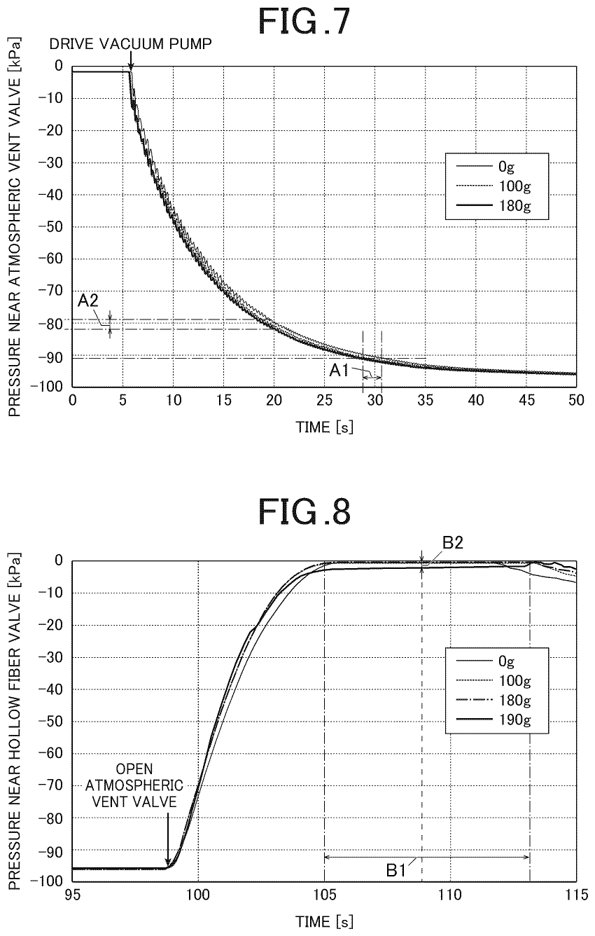

FIG. 7 is a graph illustrating the transition of the measurement value of the second pressure sensor 482 with the driving of the vacuum pump 484 in step S103. In FIG. 7, the X-axis (horizontal axis) represents the elapsed time, and the Y-axis (vertical axis) represents the measurement value of the second pressure sensor 482. Note that in the following example, it is assumed that the maximum capacity of the first trap 481 is 220 g and the flow rate of the vacuum pump 484 is 6 L/min.

As indicated by the arrow A1 in FIG. 7, for example, when the liquid amount in the first trap 481 is 180 g, the number of seconds required for the measurement value of the second pressure sensor 482 to reach −90 kPa from the start of driving of the vacuum pump 484 is shorter by about 7 seconds than when the liquid amount in the first trap 481 is 0 g. This is because, when the liquid amount in the first trap 481 is large, the air amount in the first trap 481 decreases correspondingly and the speed of increase in negative pressure increases.

FIG. 8 is a graph illustrating the transition of the measurement value of the first pressure sensor 471 in step S106 associated with the opening of the atmospheric vent valve 483 according to the liquid amount in the first trap 481. In FIG. 8, the X-axis (horizontal axis) represents the elapsed time, and the Y-axis (vertical axis) represents the measurement value of the first pressure sensor 471. Note that in the present embodiment, when the liquid amount in the first trap 481 is 190 g, the liquid level height of the first trap 481 reaches the inlet port 4811.

As illustrated in FIG. 8, for example, there is no large difference in the time required for the measurement value of the first pressure sensor 471 to reach 0 kPa between the case where the liquid amount in the first trap 481 is 0 g and the cases where the liquid amounts are 100 g and 180 g. On the other hand, as illustrated by the arrow B1 in FIG. 8, when the liquid amount in the first trap 481 is 190 g, the number of seconds required for the measurement value of the first pressure sensor 471 to reach 0 kPa is longer by about 7 seconds than when the liquid amount is 0 g. This is because, as illustrated in FIG. 4, when the liquid level height of the first trap 481 reaches the inlet port 4811, the air flow resistance at the inlet port 4811 increases and the deceleration speed of the negative pressure decreases.

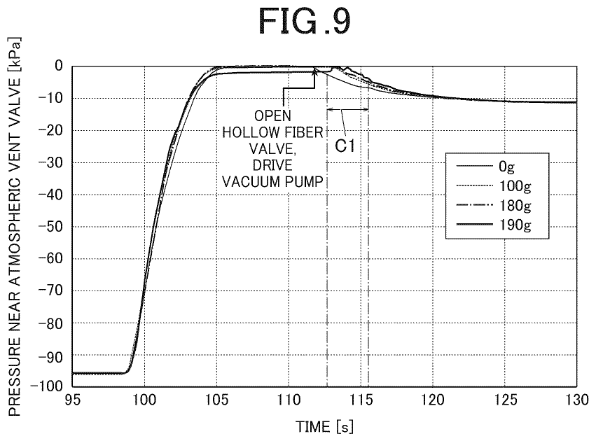

FIG. 9 is a graph illustrating the transition of the measurement value of the second pressure sensor 482 in step S110 associated with the opening of the hollow fiber valve 472 and the driving of the vacuum pump 484 according to the liquid amount in the first trap 481. In FIG. 9, the X-axis (horizontal axis) represents the elapsed time, and the Y-axis (vertical axis) represents the measurement value of the second pressure sensor 482.

As illustrated by the arrow C1 in FIG. 9, when the liquid amount in the first trap 481 is 190 g, the number of seconds required for the measurement value of the second pressure sensor 482 to reach −5 kPa is longer by about 3 seconds than when the liquid amount is 0 g. This is because, similarly to the example of FIG. 8, when the liquid level height of the first trap 481 reaches the inlet port 4811, the air flow resistance at the inlet port 4811 increases and the deceleration speed of the negative pressure decreases.

For example, in each step, the controller 50 pre-stores in the ROM 53 a table summarizing the correspondence relationship between the numbers of seconds required for the respective measurement values of the first and second pressure sensors 471 and 482 to reach respective predetermined values from respective predetermined timings and the liquid amount in the first trap 481. Then, the controller 50 detects the liquid amount in the first trap 481 by referring to the number of seconds acquired in each step and the table.

Thus, the controller 50 can detect the liquid amount in the first trap 481 based on the measurement value(s) of the first pressure sensor 471 and/or the second pressure sensor 482. In particular, when a height difference is provided between the inlet port 4811 and the discharge port 4812 in the first trap 481, it is possible to detect whether the liquid level height of the first trap 481 reaches the inlet port 4811.

Note that although the liquid level height of the first trap 481 is detected based on the measurement value acquired by the controller 50 in the three steps in the above description, the present invention is not limited thereto. That is, the controller 50 may detect the liquid level height of the first trap 481 based on the measurement value acquired in one or two of the steps.

Furthermore, although the liquid amount in the first trap 481 is detected based on the number of seconds for the measurement value of the second pressure sensor 482 to reach the predetermined value in step S103, the present invention is not limited thereto. As indicated by the arrow A2 in FIG. 7, the controller 50 may detect the liquid amount in the first trap 481 based on the measurement value of the second pressure sensor 482 after a predetermined time from the start of driving of the vacuum pump 484.

Similarly, in step S106, as indicated by the arrow B2 in FIG. 8, the controller 50 may detect the liquid level height of the first trap 481 based on the measurement value of the first pressure sensor 471 after a predetermined time from the opening of the atmospheric vent valve 483. Further, in step S109, the controller 50 may detect the liquid level height of the first trap 481 based on the measurement value of the second pressure sensor 482 after a predetermined time from the opening of the hollow fiber valve 472 and the driving of the vacuum pump 484.

However, the time has a higher resolution than the pressure value. Therefore, a configuration in which the controller 50 detects the liquid amount in the first trap 481 based on the number of seconds required for the pressure to reach a predetermined pressure value is preferable because the liquid amount in the first trap 481 can be more accurately detected.

Furthermore, although the configuration in which the controller 50 directly detects the liquid amount in the first trap 481 based on the detection result of each step has been illustrated, the present invention is not limited thereto. When the capacity of the first trap 481 is stored in advance in the ROM 53, the controller 50 may detect the air amount in the first trap 481 and then detect the liquid amount by subtracting the air amount from the capacity of the first trap 481.

Returning to FIG. 6, the controller 50 determines whether the liquid amount in the first trap 481 detected in step S112 is equal to or greater than a predetermined value and the liquid level height is equal to or greater than a predetermined value (step S113). For example, the controller 50 determines whether the liquid level height of the first trap 481 is higher than the inlet port 4811. If the liquid level height of the first trap 481 is equal to or greater than the predetermined value (step S113; Yes), the controller 50 stops driving the vacuum pump 484. Then, the controller 50 causes the notification section 60 to notify the user to discharge the ink in the first trap 481 (step S114).

On the other hand, if the liquid level height of the first trap 481 has not reached the inlet port 4811 (step S113; No), there is still room in the first trap 481, and thus the controller 50 continues driving the vacuum pump 484 (step S115). By the control in step S112 to S115, the first trap 481 can be cleaned at an appropriate timing.

### Effects of First Embodiment

As described above, the inkjet recording apparatus 100, which is the liquid ejection apparatus according to the present embodiment, includes the first trap 481, which is a liquid reservoir that stores liquid, and the first vacuum path 47 and the second vacuum path 48, which are paths that communicate with the liquid reservoir. In addition, the inkjet recording apparatus 100 includes the vacuum pump 484, which is a pump that sucks air from the liquid reservoir via the second vacuum path 48 of the paths, and the first pressure sensor 471 and the second pressure sensor 482, which are pressure gauges that measure the pressure in the paths. In addition, the inkjet recording apparatus 100 includes the controller 50 functioning as a sensing section that detects the liquid amount in the liquid reservoir based on the detection results of the pressure gauges. According to the above configuration, the liquid amount in the first trap 481 can be detected by the pressure gauges that measure the suction amount of the vacuum pump 484 without providing a liquid amount sensor in the first trap 481.

### Second Embodiment

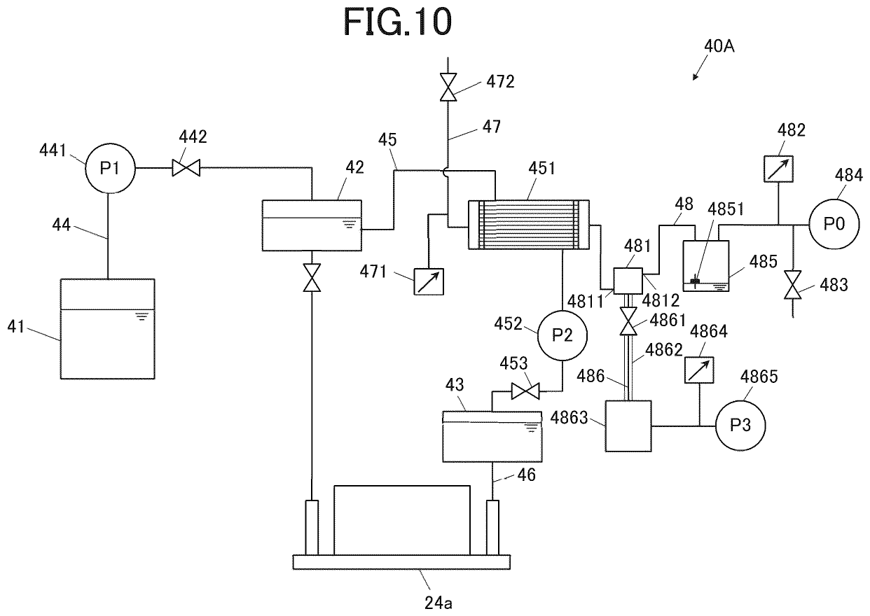

Next, the liquid amount detection processing in an inkjet recording apparatus 100 according to the second embodiment will be described. In the following description, the same components as those of the first embodiment are denoted by the same reference numerals, and the detailed description thereof will be omitted. FIG. 10 is a schematic configuration diagram of a liquid feed section 40A according to the second embodiment. The liquid feed section 40A according to the second embodiment is different from the liquid feed section 40 according to the first embodiment in that a second trap 485 and a discharge channel 486 are provided in the second vacuum path 48.

### Second Trap

The second trap 485 stores the liquid component of ink that has not been trapped by the first trap 481. Furthermore, when the gas permeable membrane 4512 is broken and a large amount of ink leaks out, the second trap 485 receives and stores ink that cannot be stored in the first trap 481.

As described above, the second trap 485 mainly functions as an ink buffer at the time of malfunction of the deaeration module 451. Therefore, the second trap 485 is provided so as to have a larger capacity than the first trap 481. The second trap 485 is provided with a known liquid level sensor 4851, and the controller 50 stops various operations when the controller 50 detects that the liquid amount in the second trap 485 is equal to or greater than a predetermined value. This control prevents the second trap 485 from becoming completely filled with ink components, thereby suppressing the overflow of liquid ink components that could cause the vacuum pump 484 to malfunction.

### Discharge Channel

The discharge channel 486 is a channel provided so as to communicate with a lower portion of the first trap 481 in the liquid feed section 40 of each color ink. The discharge channel 486 is a liquid channel through which the liquid component of the ink stored in the first trap 481 flows. The discharge channel 486 is provided with a discharge valve 4861, a liquid heater 4862, a liquid discharger 4863, a pressure detector 4864, and a suction pump 4865.

### Discharge Valve

The discharge valve 4861 is a solenoid valve that can be opened and closed under the control of the controller 50. The discharge valve 4861 is normally closed and is opened by the controller 50 at the timing when the liquid component of the ink is discharged from the first trap 481.

### Liquid Heater

The liquid heater 4862 suppresses clogging of the discharge channel 486 with the liquid component of the ink by heating the discharge channel 486. FIG. 10 illustrates the case where the liquid heater 4862 includes a heat transfer member that transfers heat from a heater, but the liquid heater 4862 may be, for example, the heater itself. As a heater constituting an ink heater (the liquid heater), a heating wire that generates Joule heat when energized is used, for example. As a heat transfer member constituting an ink heater (the liquid heater), a member having high heat conductivity, for example, a heat conductive plate formed of various metals (alloys) is used.

### Liquid Discharger

The liquid discharger 4863 is directly connected to the discharge channel 486, and the liquid component of the ink discharged from the first trap 481 of each color ink is discharged therefrom. The liquid discharger 4863 is formed of, for example, a plastic or metal bottle.

Note that while the first trap 481 needs to be located inside the inkjet recording apparatus 100 and between the deaeration module 451 and the vacuum pump 484, the liquid discharger 4863 need only communicate with the first trap 481 via the discharge channel 486. Therefore, the liquid discharger 4863 can be installed in any place such as the outside of the inkjet recording apparatus 100, and the capacity of the liquid discharger 4863 can be set to be larger than the capacity of the first trap 481. Specifically, the capacity of the first trap 481 is about 200 ml, and the capacity of the liquid discharger 4863 is about 4000 ml.

### Pressure Detector

The pressure detector 4864 is a known pressure gauge. The pressure detector 4864 detects the pressure value of the discharge channel 486 and sequentially transmits the detection results to the controller 50.

### Suction Pump

The suction pump 4865 has substantially the same configuration as the vacuum pump 484. The suction pump 4865 causes the liquid component of the ink in the first trap 481 to be discharged to the liquid discharger 4863 by depressurizing the discharge channel 486.

### Liquid Amount Detection Processing (Second Embodiment)

In the inkjet recording apparatus 100 according to the second embodiment as described above, the liquid amount in the liquid discharger 4863 can be detected by substantially the same method as the liquid amount detection in step S103 of the first embodiment.

In detail, when the suction pump 4865 is driven while the discharge valve 4861 is closed, a time required for the pressure detector 4864 to detect a predetermined pressure value (or a pressure value detected by the pressure detector 4864 after a predetermined time) changes according to the liquid amount in the liquid discharger 4863. Therefore, the controller 50 can detect the liquid amount in the liquid discharger 4863 based on the time or the pressure value.

### Effects of Second Embodiment

As described above, the inkjet recording apparatus 100 according to the second embodiment includes the deaeration module 451 that is capable of removing dissolved gas in liquid, and the first trap 481, which is a trap that stores liquid having passed through the gas permeable membrane 4512. The liquid reservoir is the liquid discharger 4863 that stores liquid discharged from the first trap 481. In the above-described configuration as well, the liquid amount in the liquid discharger 4863 can be detected without providing a liquid amount sensor, and thus it is possible to prevent the suction pump 4865 from malfunctioning.

In the inkjet recording apparatus 100 according to the second embodiment, the liquid reservoir capable of detecting the liquid amount is not limited to the liquid discharger 4863. That is, the liquid amount in the second trap 485 may be detected without providing the liquid level sensor 4851 in the second trap 485 or the liquid amount in the first trap 481 may be detected similarly to the first embodiment. However, when the liquid amount in the first trap 481 or the second trap 485 is detected, the measurement values of the first pressure sensor 471 and the second pressure sensor 482 change according to the liquid amount in one as well as the other. Therefore, for example, the controller 50 preferably corrects the detection result of the liquid amount in the first trap 481 based on the measurement result of the liquid level sensor 4851. In addition, it is preferable that the controller 50 performs the liquid amount detection processing on the second trap 485 after discharging the liquid component of the ink in the first trap 481 to the liquid discharger 4863. When the controller 50 performs detection of the liquid amount in the liquid discharger 4863, it is also preferable to perform the detection after the liquid component of the ink in the first trap 481 is discharged to the liquid discharger 4863.

Furthermore, although the configuration in which the two traps of the first trap 481 and the second trap 485 are provided and the discharge channel 486 is connected to the first trap 481 has been illustrated above, the present invention is not limited thereto. For example, a configuration may be adopted in which only a single trap (the first trap 481) is provided without providing a plurality of traps, and the discharge channel 486 is connected to the single trap.

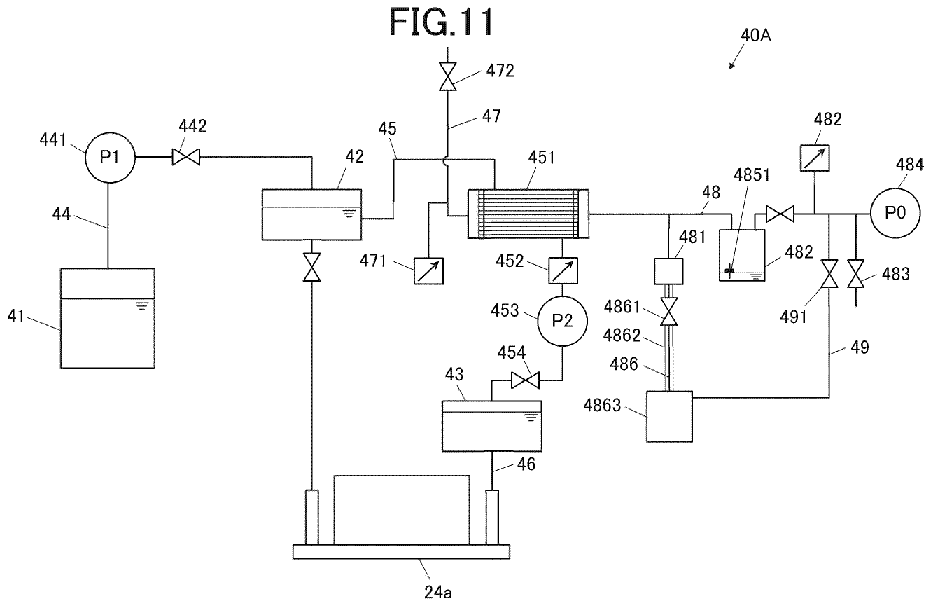

FIG. 10 illustrates the configuration including a plurality of pumps (the vacuum pump 484 and the suction pump 4865) and a plurality of pressure sensors (the second pressure sensor 482 and the pressure detector 4864), but the present invention is not limited thereto. For example, as illustrated in FIG. 11, a configuration may be adopted in which an air channel 49 that connects the liquid discharger 4863 and the second vacuum path 48 is provided, and the opening and closing of a solenoid valve 491 provided in the air channel 49 switches between depressurizing the first trap 481 and the second trap 485 and depressurizing the liquid discharger 4863. Furthermore, a configuration may be adopted in which the channel from the discharge valve 4861 to the solenoid valve 491 is used as a cleaning tool and is attached only when the first trap 481 is discharged.

### Other Configurations

The scope of the present disclosure is not limited to the above-described embodiments and includes the scope of the present invention described in the claims and the scope of equivalents thereof.

For example, in the above description, a configuration is exemplified in which the liquid amount in the first trap 481 or the liquid discharger 4863, which is the liquid reservoir, is detected, but the present invention is not limited thereto. For example, when a known pressure gauge is provided in the supply pipe 44, the liquid amount can be similarly detected by depressurizing the inside of the main tank 41 by the supply pump 441, and therefore, the liquid amount detection may be performed with the main tank 41 as the liquid reservoir.

Furthermore, in the above description, the liquid amount in the first trap 481 is detected by referring to the measurement value of the second pressure sensor 482 after a predetermined time from the driving of the vacuum pump 484 and the table pre-stored in the ROM 53, but the liquid amount detection method is not limited thereto. For example, when liquid adheres between the discharge port 4812 and the vacuum pump 484 in the second vacuum path 48, the suction capability of the vacuum pump 484 decreases. Further, each vacuum pump 484 has its own individual variations. Thus, when the suction capacity of the vacuum pump 484 is different from that at the time of setting of the table, an error may occur in the liquid amount detection result by the controller 50.

In order to solve the above-described problem, the second vacuum path 48 may be provided with a known flow rate sensor for measuring the amount of air sucked by the vacuum pump 484. In the above-described configuration, the controller 50 performs detection of the suction capability of the vacuum pump 484 by the flow rate sensor. Then, the controller 50 corrects the detection result of the liquid amount in the first trap 481 based on the detection result of the suction capability of the vacuum pump 484, thereby suppressing the occurrence of an error in the detection result of the liquid amount due to the difference in the suction capability of the vacuum pump 484.

Alternatively, the controller 50 may acquire the curvatures showing the changes over time as illustrated in FIGS. 7 to 9 by performing the liquid amount detection processing after discharge of the liquid in the first trap 481 or after maintenance of the first vacuum path 47 and the second vacuum path 48. Then, the liquid amount may be detected by referring to and comparing the acquired curvatures rather than the table pre-stored in the ROM 53.

In addition, a change in the viscosity of the ink according to the temperature around the first trap 481, that is, the temperature of the ink may cause an error in the liquid amount detection result by the controller 50. Therefore, a known temperature sensor for measuring the temperature of the ink may be provided in the second vacuum path 48. In the above-described configuration, the controller 50 acquires the ink temperature and corrects the detection result of the liquid amount based on the acquired temperature, thereby suppressing the occurrence of an error in the detection result of the liquid amount due to the ink temperature.

Furthermore, although the case where the liquid ejection apparatus is an inkjet recording apparatus and the liquid is ink has been described above, the present invention is not limited thereto. For example, the liquid may be a pretreatment agent, a chemical, or the like. Note that the configuration of the present disclosure functions particularly effectively when the ink is UV ink containing a gelling agent and the gas permeable membrane 4512 is made of silicone, since a monomer that is a liquid component of the ink is likely to be accumulated in the first trap 481.

Furthermore, the controller 50 may determine the presence or absence of a leak malfunction of the deaeration module 451 based on the detection result of the liquid amount in the first trap 481. For example, when the liquid amount in the first trap 481 rapidly increases in a short time, the controller 50 determines that the deaeration module 451 has a leak malfunction.

Furthermore, the controller 50 may determine the presence or absence of clogging of the channel provided with the deaeration module 451 based on the detection result of the liquid amount in the first trap 481. For example, when the liquid amount in the first trap 481 increases less than expected based on the measurement value of the pressure gauge, the controller 50 determines that the channel provided with the deaeration module 451 is clogged.

Furthermore, although the example in which the HDD is used as a computer-readable medium for the program according to the present disclosure has been disclosed above, the present invention is not limited to this example. As another computer-readable medium, a portable recording medium such as a CD-ROM can be applied. Furthermore, a carrier wave may also be used as a medium for providing data of the program according to the present disclosure via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. A liquid ejection apparatus comprising:
a liquid reservoir that stores liquid;
a path that communicates with the liquid reservoir;
a pump that sucks air from the liquid reservoir via the path;
a pressure gauge that measures a pressure in the path; and
a hardware processor that detects a liquid amount in the liquid reservoir based on a detection result of the pressure gauge.

2. The liquid ejection apparatus according to claim 1, further comprising a deaeration module that is capable of removing a dissolved gas in the liquid, wherein the liquid reservoir is a trap that stores the liquid that has passed through the deaeration module.

3. The liquid ejection apparatus according to claim 1, further comprising:
a deaeration module that is capable of removing a dissolved gas in the liquid; and
a trap that stores the liquid that has passed through the deaeration module, wherein
the liquid reservoir is a liquid discharger that stores the liquid discharged from the trap.

4. The liquid ejection apparatus according to claim 1, wherein the hardware processor detects an air amount or the liquid amount in the liquid reservoir based on a time required for a measurement value of the pressure gauge to reach a predetermined value from a starting time of driving the pump.

5. The liquid ejection apparatus according to claim 1, wherein the hardware processor detects an air amount or the liquid amount in the liquid reservoir based on a measurement value of the pressure gauge after a predetermined time from a starting time of driving the pump.

6. The liquid ejection apparatus according to claim 1, wherein
the liquid reservoir includes:
an upstream inlet port into which the liquid flows; and
a downstream discharge port, and
the discharge port is provided with a height difference so as to be located above the inlet port.

7. The liquid ejection apparatus according to claim 6, wherein the inlet port and/or the discharge port includes a fitting that provides the height difference.

8. The liquid ejection apparatus according to claim 6, wherein the hardware processor
blows a gas into the liquid reservoir after depressurizing the liquid reservoir by driving the pump, and then
detects, based on a time required for a measurement value of the pressure gauge to reach a predetermined value, a change in flow resistance of the inlet port and whether a liquid level of the liquid reservoir has reached the inlet port.

9. The liquid ejection apparatus according to claim 6, wherein the hardware processor
blows a gas into the liquid reservoir after depressurizing the liquid reservoir by driving the pump, and then
detects, based on a measurement value of the pressure gauge after a predetermined time from a starting time of blowing the gas into the liquid reservoir, a change in flow resistance of the inlet port and whether a liquid level of the liquid reservoir has reached the inlet port.

10. The liquid ejection apparatus according to claim 8, further comprising
an atmospheric vent valve that switches, by opening and closing, the liquid reservoir between being communicated with an atmosphere and being blocked off from the atmosphere, the atmospheric vent valve being disposed downstream of the discharge port in the path, wherein
the hardware processor
depressurizes the liquid reservoir to a negative pressure by driving the pump after closing the atmospheric vent valve, and then
blows the gas into the liquid reservoir by opening the atmospheric vent valve.

11. The liquid ejection apparatus according to claim 8, further comprising a hollow fiber valve that switches, by opening and closing, the liquid reservoir between being communicated with an atmosphere and being blocked off from the atmosphere, the hollow fiber valve being disposed upstream of the inlet port in the path, wherein the hardware processor blows the gas into the liquid reservoir by driving the pump when the hollow fiber valve is opened.

12. The liquid ejection apparatus according to claim 2, wherein the hardware processor corrects a detection result of the liquid amount in the liquid reservoir based on at least one of a pressure change after discharge of the liquid from the liquid reservoir, a pressure change after maintenance of the path that communicates with the deaeration module, or a temperature of the liquid.

13. The liquid ejection apparatus according to claim 2, wherein
the liquid is ink that contains a gelling agent, and
the deaeration module includes a gas permeable membrane that is made of silicone.

14. The liquid ejection apparatus according to claim 2, wherein the hardware processor determines presence or absence of a leak malfunction of the deaeration module based on a detection result of the liquid amount in the liquid reservoir.

15. The liquid ejection apparatus according to claim 2, wherein the hardware processor determines presence or absence of clogging of a liquid channel that includes the deaeration module based on a detection result of the liquid amount in the liquid reservoir.

16. A liquid amount detection method executed by a liquid ejection apparatus that includes:
a liquid reservoir that stores liquid;
a path that communicates with the liquid reservoir;
a pump that sucks air from the liquid reservoir via the path; and
a pressure gauge that measures a pressure in the path,
the method comprising detecting a liquid amount in the liquid reservoir based on a detection result of the pressure gauge.

17. A non-transitory computer-readable storage medium storing a program to be executed by a computer of a liquid ejection apparatus that includes:
a liquid reservoir that stores liquid;
a path that communicates with the liquid reservoir;
a pump that sucks air from the liquid reservoir via the path; and
a pressure gauge that measures a pressure in the path,
the program causing the computer to detect a liquid amount in the liquid reservoir based on a detection result of the pressure gauge.
